(19) United States
(12) Patent Application Publication
(10) Pub. No.: US 2006/0013267 A1
(43) Pub. Date: Jan. 19, 2006

(54) Integrated branching network system

(75) Inventors: Katsuya Fujihira, Shizuoka-ken (JP); Sayaka Aoshima, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: YAZAKI CORPORATION

(21) Appl. No.: 11/179,677

(22) Filed: Jul. 13, 2005

(30) Foreign Application Priority Data
Jul. 13, 2004 (JP) P2004-206001

(51) Int. Cl. H04J 3/04

(52) U.S. Cl. 370/535

(57) ABSTRACT

A network system is provided with plural branch lines for respectively linking with nodes, each of the branch lines including a transmission line and a reception line; a branching point linked with the reception lines, the branching point including and being linked with a switching device for selectively establishing contact with one selected from the transmission lines and separating the others of the transmission lines, wherein the transmission lines are so regulated as to have characteristic impedances respectively matching with a total of characteristic impedances of the reception lines and a trunk line for linking the branching point with an external branching point.

### BACKGROUND OF THE INVENTION

1. Field of the Invention

The present invention in general relates to an integrated branching network system and in particular relates to an art for reduction of distortions of a waveform at branching points existing on the network system.

2. Description of the Related Art

Vehicles are these days equipped with network systems for communication of signals for controlling various electronic equipments. Such a network system is typically provided with a main line and a plurality of nodes and branching points linking the nodes with the main line. Japanese Patent Application Laid-open No. 2000-151153 discloses an art of the network system. In these network systems, distortions of waveforms of data signals are investigated in certain cases and often cause occurrence of data errors.

### SUMMARY OF THE INVENTION

The inventors had found out that particular branching points to which plural branch nodes are centralized and connected cause considerable impedance mismatches, which lead to the distortions of the waveforms. The present invention was accomplished in view of the finding and is intended for providing an integrated branching network system, which reduces distortions of a waveform at branching points existing on the network system.

According to a first aspect of the present invention, a network system is provided with: plural branch lines for respectively linking with nodes, each of the branch lines including a transmission line and a reception line; a branching point linked with the reception lines, the branching point including and being linked with a switching device for selectively establishing contact with one selected from the transmission lines and separating the others of the transmission lines, wherein the transmission lines are so regulated as to have characteristic impedances respectively matching with a total of characteristic impedances of the reception lines and a trunk line for linking the branching point with an external branching point.

According to the above constitution, a characteristic impedance of the transmission line matches the total of characteristic impedances of the plural reception lines and a main line. Thereby distortion of the waveform transmitted from the transmission node comes to be minimum. This leads to improvement in reliability of a data communication.

The transmission lines and the reception lines may be so configured as to satisfy an equation of Z0r=n·Z0, where Z0 represents the characteristic impedances of the transmission lines, Z0r represents the characteristic impedances of the reception lines and n represents a number of the branch lines linked with the branching point.

According to the above constitution, quality of the impedance match at the particular branching point is further improved. This leads to improvement in reliability of a data communication.

The network system may be further provided with: plural second branch lines for respectively linking with second nodes, each of the second branch lines including a second transmission line and a second reception line; a second branching point linked with the second reception lines, the second branching point including and being linked with a second switching device for selectively switching on one selected from the second transmission lines and switching off the others of the second transmission lines, the second branching point linked with the branching point via the trunk line, wherein the transmission lines, the reception lines, the second transmission lines, the second reception lines and the trunk line are so configured as to satisfy equations of Z0r=2·x·Z0 and Z0r=2·y·Z0, where Z0r represents the characteristic impedances of the reception lines and the second reception lines, Z0 represents the characteristic impedances of the transmission lines, Z0r represents the characteristic impedances of the reception lines and the second reception lines, x represents a number of the branch lines linked with the branching point and y represents a number of the second branch lines linked with the second branching point.

According to the above constitution, quality of the impedance match is further improved particularly in a case where the first branching point and the second branching point are interconnected.

The nodes may be ECUs equipped on a vehicle.

According to the above constitution, reliability of a data communication between ECUs equipped on a vehicle can be improved.

### BRIEF DESCRIPTION OF THE DRAWINGS

FIG. 1 is a block diagram of an integrated branching network system in accordance with a first embodiment of the present invention;

FIG. 2 is a graph illustrating a waveform transmitted from a node;

FIG. 3 is a flow chart with respect to an operation of the network system; and

FIG. 4 is a block diagram of an integrated branching network system in accordance with a second embodiment of the present invention.

### DETAILED DESCRIPTION OF THE PREFERRED EMBODIMENT

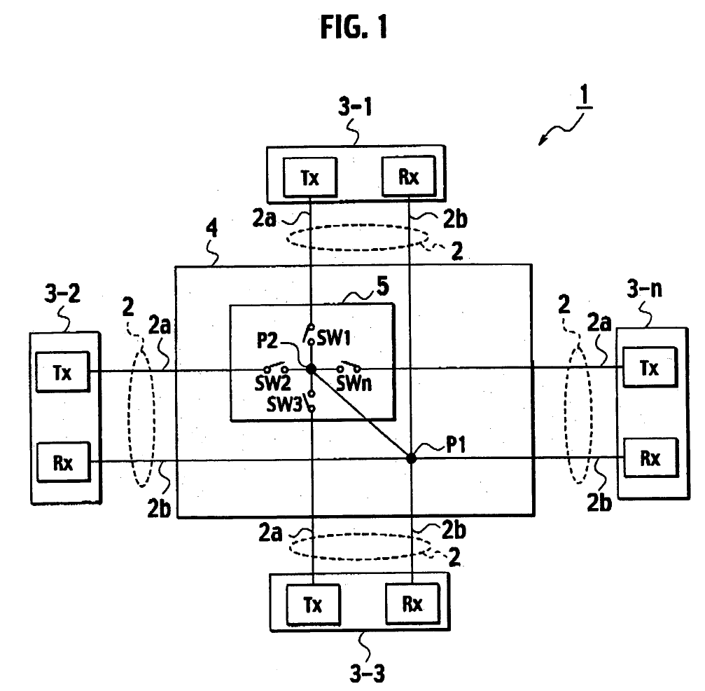

A first embodiment of the present invention will be described hereinafter with reference to FIGS. 1 to 3. A network system 1 in accordance with the first embodiment is provided with a branching part 4, plural nodes 3 (FIG. 1 exemplarily illustrates a case including n nodes 3-1 to 3-n), branch lines 2 for respectively linking the nodes 3 (3-1 to 3-n) with the branching part 4 and a switching device 5 included in the branching part 4.

These nodes are for example respective ECUs (Electronic Control Unit) equipped in a vehicle.

Each of the branch lines 2 is composed of a transmission line 2a linking with a transmission part Tx of the node 3 and a reception line 2b linking with a reception part Rx of the node 3. The plural reception lines 2b are interlinked at a point P1 of the branching part 4.

The plural transmission lines 2a are interlinked at a point P2 via switching device 5. More specifically, the transmission line 2a linking with the transmission part Tx of the node 3-1 links with the point P2 via a switch SW1 and the-transmission line 2a linking with the node 3-2 links with the point P2 via a switch SW2. The same applies to the other nodes 3-3 to 3-n. Moreover the point P1 and the point P2 are interlinked.

The branching part 4 uses the switching device 5 to control ON and OFF of the respective switches SW1 to SWn by later described operation procedures.

Each of the transmission lines 2a has a characteristic impedance Z0 and each of the reception lines 2b has a characteristic impedance Z0r. The characteristic impedance Z0r is regulated to be n times as great as the impedance Z0. More specifically, Z0r=n·Z0.

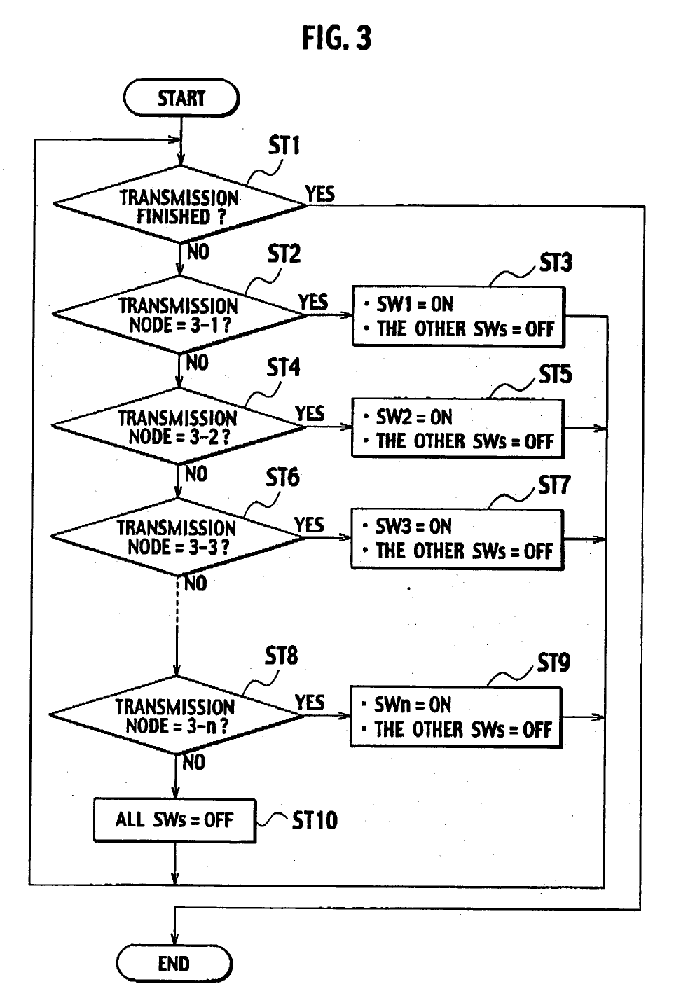

An operation of the network system of the present embodiment will be described hereinafter with reference to FIG. 3.

In a state that communications are established through the network system 1, when the transmission node is established, switching of the switches SW1 to SWn are accomplished correspondently to the transmission node.

In a case where the node 3-1 is established as the transmission node (a conditional branch step ST2: YES), the switch SW1 is switched ON and the other switches SW2 to SWn are switched OFF (Step ST3).

Meanwhile, in a case where the step ST2 is NO, the step moves to a step ST4. In case where the node 3-2 is established as the transmission node (a conditional branch step ST4: YES), the switch SW2 is switched ON and the other switches SW1 and SW3 to SWn are switched OFF (Step ST5).

In a case where the step ST4 is NO, the step moves to a step ST6. If NO, the same steps are subsequently accomplished. If any of subsequent conditional branch steps is decided to be YES, a correspondent switch selected from the switches SW3 to SWn is switched ON and the other switches are switched OFF.

Finally, if all the conditional branch steps are decided to be NO, namely all the nodes 3 are not in a transmission state, all the switches SW1 to SWn are switched OFF (Step ST10).

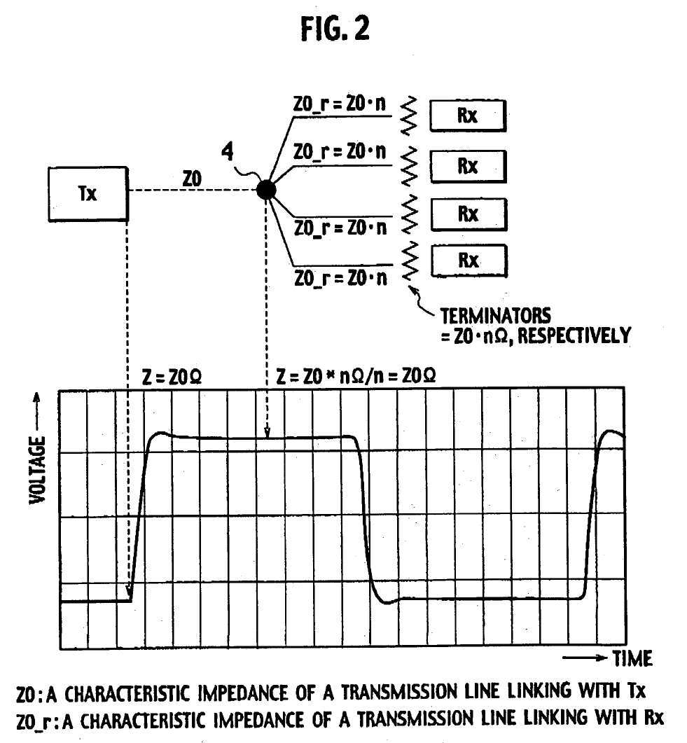

FIG. 2 illustrates a waveform of a transmission signal transmitted from the node 3-1 accompanied with an equivalent circuit of the network system 1 when the node 3-1 is established as the transmission node.

As described above, since each of the reception lines 2b has a characteristic impedance Z0r which is n times as great as the characteristic impedance Z0 of the transmission lines 2a, a characteristic impedance of the transmission line 2a from the node 3-1 to the branching part 4 comes to be Z0 and a total of characteristic impedances of the reception lines 2b beyond the branching part 4 similarly comes to be Z0. Thereby the impedances match with each other at the branching part 4.

Because of the impedance match, as shown in FIG. 2, the waveform of the signal transmitted from the node 3-1 is transmitted to the respective nodes 3-2 to 3-n as receivers without distortion.

As constituted in accordance with the above description, the network system 1 is provided with the plural branch lines 2 for respectively linking with the nodes 3, which respectively have the transmission lines 2a and the reception lines 2b, so that any of the transmission lines 2a has a characteristic impedance matching with a total of characteristic impedances of the reception lines 2b. Therefore, a relatively great change in characteristic impedance at the branching part 4 can be prevented and distortion of the waveform passing through the branching part 4 can be prevented. This leads to improvement of reliability of data transmission.

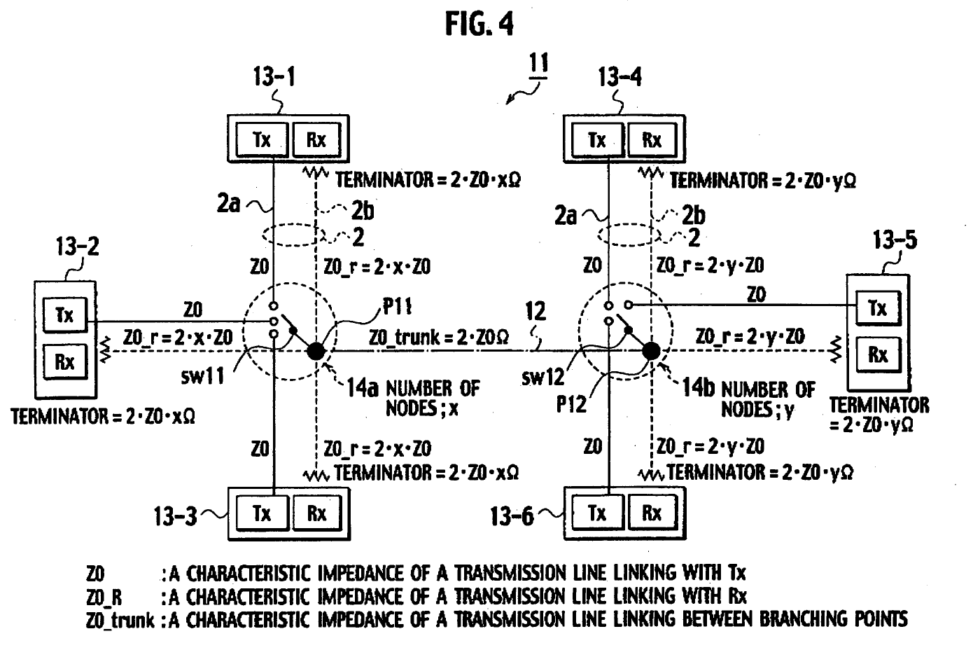

A second embodiment of the present invention will be described herein after with reference to FIG. 4. A network system 11 is provided with a trunk line 12 and branching parts 14a and 14b respectively linked with both ends of the trunk line 12. The branching part 14a is provided with plural (three in this example) nodes 13 (13-1 to 13-3) and branch lines 2 for respectively linking the nodes 13 with the branching part 14a. Similarly, the branching part 14b is provided with plural (three in this example) nodes 13 (13-4 to 13-6) and branch lines 2 for respectively linking the nodes 13 with the branching part 14b.

Each of the branch lines 2 of the branching parts 14a and 14b is composed of a transmission line 2a linking with a transmission part Tx of the node 3 and a reception line 2b linking with a reception part Rx of the node 3. The reception lines 2b linked with the nodes 13-1 to 13-3 are interlinked at a point P11 and the reception lines 2b linked with the nodes 13-4 to 13-6 are interlinked at a point P12. The points P11 and P12 are interlinked via the trunk line 12.

The branching parts 14a and 14b are respectively provided with switches SW11 and SW12. The switch SW11 is linked with the point P11 and configured to selectively establish contact with any of the transmission lines 2a linked with the nodes 13-1 to 13-3. Similarly the switch SW12 is linked with the points P12 and configured to selectively establish contact with any of the transmission lines 2a linked with the nodes 13-4 to 13-6. The network system 11 is capable of establishing data communication between any transmitting node and the other receiving node by switching the switches SW11 and SW12 so as to switch link among the transmission lines 2a and the reception lines 2b.

Each of the transmission lines 2a linked with the nodes 13-1 to 13-3 has a characteristic impedance Z0 and each of the reception lines 2b. linked with the nodes 13-1 to 13-3 has a characterisitic impedance Z0r. The characteristic impedance Z0r is regulated to be 2-x times (three times in this example) as great as the impedance Z0. More specifically, Z0r=2·x·Z0.

Similarly, each of the transmission lines 2a linked with the nodes 13-4 to 13-6 has a characteristic impedance Z0 and each of the reception lines 2b linked with the nodes 13-4 to 13-6 has a characterisitic impedance Z0r. The characteristic impedance Z0r is regulated to be 2·y times (three times in this example) as great as the impedance Z0. More specifically, Z0r=2·y·Z0.

Moreover, a characteristic impedance Z0_trunk of the trunk line 12 is regulated to be 2 times as great as the impedance Z0, more specifically, Z0_trunk=2·Z0.

An operation of the network system of the present embodiment will be described hereinafter. A case where the node 13-1 transmits a data is supposed. In this case, the switch SW11 of the branching part 14a is switched to establish contact with the transmission line 2a linked with the node 13-1. The characteristic impedance of the transmission line 2a is Z0.

Since the characteristic impedances Z0r of the respective reception lines 2b are 2·x·Z0 (provided x=3) and the characteristic impedance Z0_trunk of the trunk line 12 is 2·Z0 as mentioned above, a characteristic impedance beyond the point P11 from the view of the transmitting node comes to be Z0. Therefore the impedances match with each other at the branching part 14a and hence a waveform of the signal transmitted from the node 13-1 is prevented from distortion. The same applies to any case where any of the nodes 13-2 and 13-3 transmits a data.

Moreover, in any case where any of the nodes 13-4 to 13-6 branched from the branching part 14b transmits a data, a characteristic impedance beyond the point P12 from the view of the transmitting node comes to be Z0 and hence distortion of a waveform can be prevented. Thereby, reliability of data transmission between any transmitting node and the other receiving node can be ensured.

As constituted in accordance with the above description, the network system 11 is provided with the branching points 14a and 14b so that distortion of the wave format the branching points 14a and 14b is effectively prevented even though the branching points 14a and 14b are interlinked via the trunk line 12. This leads to improvement of reliability of data transmission.

Although the invention has been described above by reference to certain embodiments of the invention, the invention is not limited to the embodiments described above. Modifications and variations of the embodiments described above will occur to those skilled in the art, in light of the above teachings.

For example, the number of the branching points is not limited to be one as the first embodiment or two as the second embodiment. Three or more branching points may be included in the network system under a condition that characteristic impedances of transmission lines, reception lines and trunk lines are so regulated as to match with each other at the respective branching points.

Moreover, the above description are given with an example that the nodes are ECUs equipped on a vehicle, however, the above embodiments can be applied to any other communication device.

What is claimed is:

1. A network system comprising:
plural branch lines for respectively linking with nodes, each of the branch lines including a transmission line and a reception line;
a branching point linked with the reception lines, the branching point including and being linked with a switching device for selectively establishing contact with one selected from the transmission lines and separating the others of the transmission lines,
wherein the transmission lines are so regulated as to have characteristic impedances respectively matching with a total of characteristic impedances of the reception lines and a trunk line for linking the branching point with an external branching point.

2. The network system of claim 1, wherein the transmission lines and the reception lines are so configured as to satisfy an equation of Z0r=n·Z0, where Z0 represents the characteristic impedances of the transmission lines, Z0r represents the characteristic impedances of the reception lines and n represents a number of the branch lines linked with the branching point.

3. The network system of claim 1, further comprising;
plural second branch lines for respectively linking with second nodes, each of the second branch lines including a second transmission line and a second reception line;
a second branching point linked with the second reception lines, the second branching point including and being linked with a second switching device for selectively switching on one selected from the second transmission lines and switching off the others of the second transmission lines, the second branching point linked with the branching point via the trunk line,
wherein the transmission lines, the reception lines, the second transmission lines, the second reception lines and the trunk line are so configured as to satisfy equations of Z0r=2·x·Z0 and Z0r=2·y·Z0, where Z0r represents the characteristic impedances of the reception lines and the second reception lines, Z0 represents the characteristic impedances of the transmission lines, Z0r represents the characteristic impedances of the reception lines and the second reception lines, x represents a number of the branch lines linked with the branching point and y represents a number of the second branch lines linked with the second branching point.

4. The network system of claim 1, wherein the nodes are ECUs equipped on a vehicle.
